(19) United States
(12) Patent Application Publication
(10) Pub. No.: US 2021/0173600 A1
(43) Pub. Date: Jun. 10, 2021

(54) IMAGE PROCESSING APPARATUS, METHOD OF CONTROLLING IMAGE PROCESSING APPARATUS, AND NON-TRANSITORY COMPUTER-READABLE STORAGE MEDIUM STORING PROGRAM

(71) Applicant: SEIKO EPSON CORPORATION, Tokyo (JP)

(72) Inventor: Ryotaro Hayashi, Shiojiri (JP)

(21) Appl. No.: 17/114,570

(22) Filed: Dec. 8, 2020

(30) Foreign Application Priority Data
Dec. 10, 2019 (JP) 2019-222735

(51) Int. Cl. G06F 3/12

(52) U.S. Cl. CPC G06F 3/1242; G06F 3/1208

(57) ABSTRACT

A control apparatus divides an image region represented by image data into a plurality of subregions and sends sectional image data corresponding to the subregions to a printer. The control apparatus includes an image processor configured to detect a first object such as a face in an image represented by the image data, locate the detected first object in the image region, and divide the image region in accordance with the position of the first object in the image region such that a subregion contains a second object region corresponding to a second object constituting the first object.

The present application is based on, and claims priority from JP Application Serial Number 2019-222735, filed Dec. 10, 2019, the disclosure of which is hereby incorporated by reference herein in its entirety.

### BACKGROUND

### 1. Technical Field

The present disclosure relates to an image processing apparatus, a method of controlling the image processing apparatus, and a non-transitory computer-readable storage medium storing a program.

### 2. Related Art

A technology of dividing an image into a plurality of image sections and printing each image section is known. For example, JP-A-2007-11679 discloses a printing system of printing each image section in which the right edge of an N-1th image section and the left edge of an Nth image section are printed at the same density.

When an image is divided into a plurality of image sections as described in JP-A-2007-11679, there is a need to ensure that particular objects such as eyes and a mouth are not allocated across a plurality of image sections. This is because, when the prints of image sections including objects such as eyes and a mouth are arranged and bonded together to obtain a single print, misalignment of the seam is likely to be conspicuous. In known technologies, however, it is necessary to manually adjust the division positions to prevent those particular objects from being divided into different image sections, which requires user's laborious work.

### SUMMARY

According to an aspect for solving the problem described above, an image processing apparatus for dividing an image region represented by image data into a plurality of subregions and sending sectional image data corresponding to the subregions to a printing apparatus includes an image processor configured to detect a first object in an image represented by the image data, determine the position of the detected first object in the image region, and in accordance with the determined position of the first object in the image region, divide the image region such that any of the subregions contains at least one second object region corresponding to at least one second object constituting the first object.

According to another aspect for solving the problem described above, a method of controlling an image processing apparatus for dividing an image region represented by image data into a plurality of subregions and sending sectional image data corresponding to the subregions to a printing apparatus includes detecting a first object in an image represented by the image data, determining the position of the detected first object in the image region, and in accordance with the determined position of the first object in the image region, dividing the image region such that any of the subregions contains at least one second object region corresponding to at least one second object constituting the first object.

According to a further aspect for solving the problem described above, a non-transitory computer-readable storage medium storing a program stores a program that causes a controller of an image processing apparatus to execute a process, the image processing apparatus being configured to divide an image region represented by image data into a plurality of subregions and send sectional image data corresponding to the subregions to a printing apparatus. The process includes detecting a first object in an image represented by the image data, determining the position of the detected first object in the image region, and in accordance with the determined position of the first object in the image region, dividing the image region such that any of the subregions contains at least one second object region corresponding to at least one second object constituting the first object.

### BRIEF DESCRIPTION OF THE DRAWINGS

FIG. 1 illustrates a configuration of a printing system.

FIG. 2 is a flowchart illustrating an operation of the printing system.

FIG. 3 illustrates an example of an image region divided in the image region division processing.

FIG. 4 is a flowchart illustrating an operation of a control apparatus in the image region division processing.

FIG. 5 is an illustration for explaining locating a face and measuring the size of a face region.

FIG. 6 is an illustration for explaining setting division lines.

FIG. 7 is an illustration for explaining setting division lines.

FIG. 8 is an illustration for explaining combining a subregion with a contiguous subregion.

FIG. 9 is an illustration for explaining detection regarding face constituent objects.

FIG. 10 is an illustration for explaining constructing a face constituent object group region.

FIG. 11 is an illustration for explaining setting division lines.

FIG. 12 is an illustration for explaining combining a subregion with a contiguous subregion.

### DESCRIPTION OF EXEMPLARY EMBODIMENTS

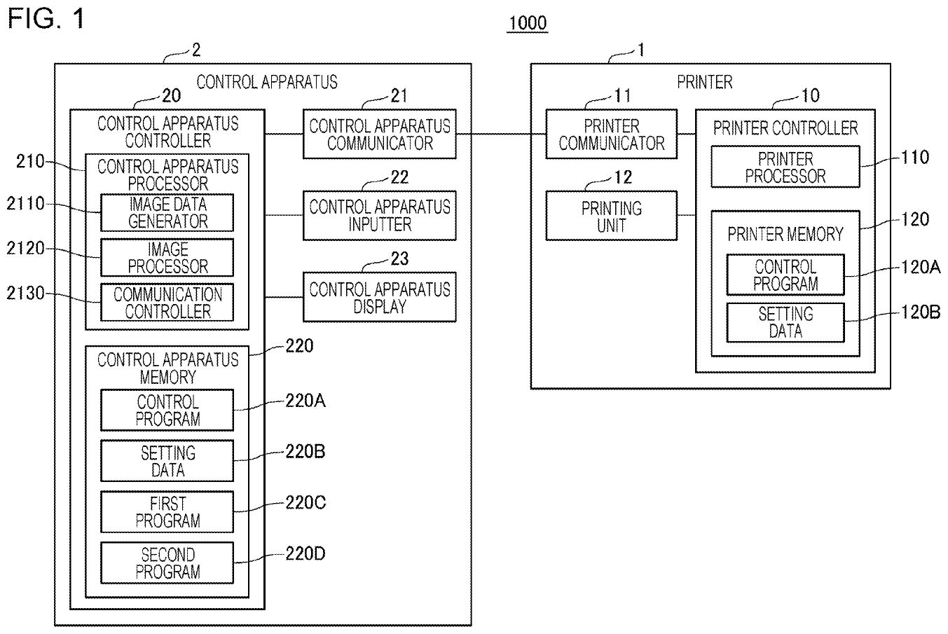

FIG. 1 illustrates a configuration of a printing system 1000. As illustrated in FIG. 1, the printing system 1000 includes a printer 1 and a control apparatus 2. The printer 1 corresponds to an example of a printing apparatus. The control apparatus 2 corresponds to an example of an image processing apparatus.

Firstly, the printer 1 will be described. The printer 1 prints text, pictures, and the like on print media by ejecting ink with the ink jet technique. As illustrated in FIG. 1, the printer 1 includes a printer controller 10, a printer communicator 11, and a printing unit 12.

The printer controller 10 includes a printer processor 110 that is a processor for running programs, such as a central processing unit (CPU) or microprocessor unit (MPU), and a printer memory 120. The printer controller 10 controls each unit of the printer 1. The printer controller 10 performs various kinds of processing with the use of hardware and software cooperating with each other such that the printer processor 110 performs processing by reading a control program 120A stored in the printer memory 120.

The printer memory 120 has a storage area for storing programs configured to be executed by the printer processor 110 and data to be processed by the printer processor 110. The printer memory 120 stores the control program 120A configured to be executed by the printer processor 110 and setting data 120B including various set values regarding the operation of the printer 1. The printer memory 120 has a non-volatile storage area for storing programs and data in a non-volatile manner. The printer memory 120 may have a volatile storage area that is configured to temporarily store programs to be executed by the printer processor 110 and data targeted for processing.

The printer communicator 11 is equipped with a hardware device conforming to a particular communication standard and communicates with the control apparatus 2 in accordance with the particular communication standard under the control of the printer controller 10. The communication standard used for communication between the printer communicator 11 and the control apparatus 2 can be a wireless or wired communication standard.

The printing unit 12 includes an ink jet head, a drive circuit for driving the ink jet head, a carriage, a scanning motor for moving the carriage in a main scanning direction crossing a transport direction, a motor driver for driving the scanning motor, a transport motor for transporting a print medium in the transport direction crossing the main scanning direction of the carriage, and other configurations relating to printing on print media. The printing unit 12 prints text, pictures, and the like on print media under the control of the printer controller 10.

Next, the control apparatus 2 will be described. The control apparatus 2 controls the printer 1 and is configured as, for example, a computer. The control apparatus 2 according to the present embodiment generates image data containing text, pictures, and the like to be printed on a print medium, generates print data in accordance with the generated image data, and sends the generated print data to the printer 1.

The control apparatus 2 includes a control apparatus controller 20, a control apparatus communicator 21, a control apparatus inputter 22, and a control apparatus display 23.

The control apparatus controller 20 includes a control apparatus processor 210 that is a processor for running programs, such as a CPU or MPU, and a control apparatus memory 220. The control apparatus controller 20 controls each unit of the control apparatus 2. The control apparatus controller 20 performs various kinds of processing with the use of hardware and software cooperating with each other such that the control apparatus processor 210 performs processing by reading a control program 220A stored in the control apparatus memory 220.

The control apparatus processor 210 reads and runs a first program 220C, so that the control apparatus controller 20 functions as an image data generator 2110. The first program 220C is a program for generating image data and is preinstalled in the control apparatus 2. The control apparatus processor 210 reads and runs a second program 220D, so that the control apparatus controller 20 functions as an image processor 2120 and a communication controller 2130. Details of the image processor 2120 and the communication controller 2130 will be described later. The second program 220D is a program for generating print data and sending the generated print data. The second program 220D is preinstalled in the control apparatus 2. The second program 220D corresponds to an example of a program.

The control apparatus memory 220 has a storage area for storing programs configured to be executed by the control apparatus processor 210 and data to be processed by the control apparatus processor 210. The control apparatus memory 220 stores the control program 220A configured to be executed by the control apparatus processor 210, setting data 220B including various set values regarding the operation of the control apparatus 2, the first program 220C, and the second program 220D. The control apparatus memory 220 has a non-volatile storage area for storing programs and data in a non-volatile manner. The control apparatus memory 220 may have a volatile storage area that is configured to temporarily store programs to be executed by the control apparatus processor 210 and data targeted for processing. While in the present embodiment the control program 220A, the first program 220C, and the second program 220D are discrete programs, these three programs may constitute one program or the first program 220C and the second program 220D may constitute one program.

The control apparatus communicator 21 is equipped with a hardware device conforming to a particular communication standard and communicates with the control apparatus 2 in accordance with the particular communication standard under the control of the printer controller 10.

The control apparatus inputter 22 includes input devices such as a keyboard, a mouse, and a touch panel. The control apparatus inputter 22 detects operations performed by users with the input devices and outputs information about the detected operations to the control apparatus controller 20. In accordance with the input from the control apparatus inputter 22, the control apparatus controller 20 performs a processing operation corresponding to the operation performed by using the input devices.

The control apparatus display 23 includes, for example, a plurality of light-emitting diodes (LEDs) and a display panel. For example, under the control of the control apparatus controller 20, the control apparatus display 23 causes the LEDs to emit or not to emit light in a predetermined mode and display information on the display panel.

As described above, the control apparatus controller 20 functions as the image data generator 2110, the image processor 2120, and the communication controller 2130.

The image data generator 2110 generates image data GD including text, pictures, and the like to be printed on a print medium and outputs the generated image data GD to the image processor 2120.

The image processor 2120 divides into a plurality of subregions BA an image region GA represented by the image data GD generated by the image data generator 2110 and generates print data for printing image sections corresponding to the respective subregions BA. The image processor 2120 outputs the generated print data to the communication controller 2130.

The communication controller 2130 sends the print data generated by the image processor 2120 to the printer 1 by using the control apparatus communicator 21.

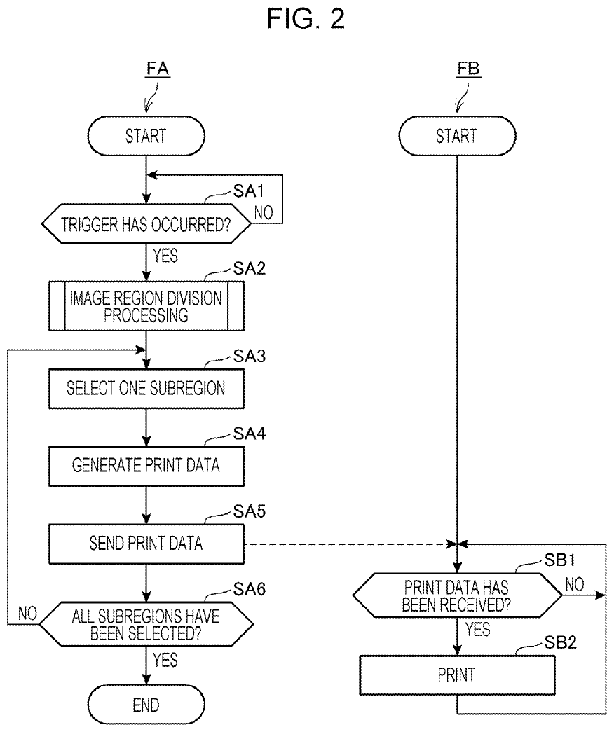

Next, the operation of the printing system 1000 will be described. FIG. 2 is a flowchart illustrating an operation of the printing system 1000. In FIG. 2, a flowchart FA illustrates an operation of the control apparatus 2. A flowchart FB illustrates an operation of the printer 1.

The image processor 2120 of the control apparatus 2 determines whether a trigger for generating print data has occurred (Step SA1). For example, the image processor 2120 determines that a trigger for generating print data has occurred in Step SA1 when the image data GD has been inputted from the image data generator 2110.

In the case in which the image processor 2120 determines that no trigger for generating print data has occurred (NO in Step SA1), the image processor 2120 performs the processing in Step SA1 again.

By contrast, in the case in which the image processor 2120 determines that a trigger for generating print data has occurred (YES in Step SA1), the image processor 2120 performs image region division processing (Step SA2).

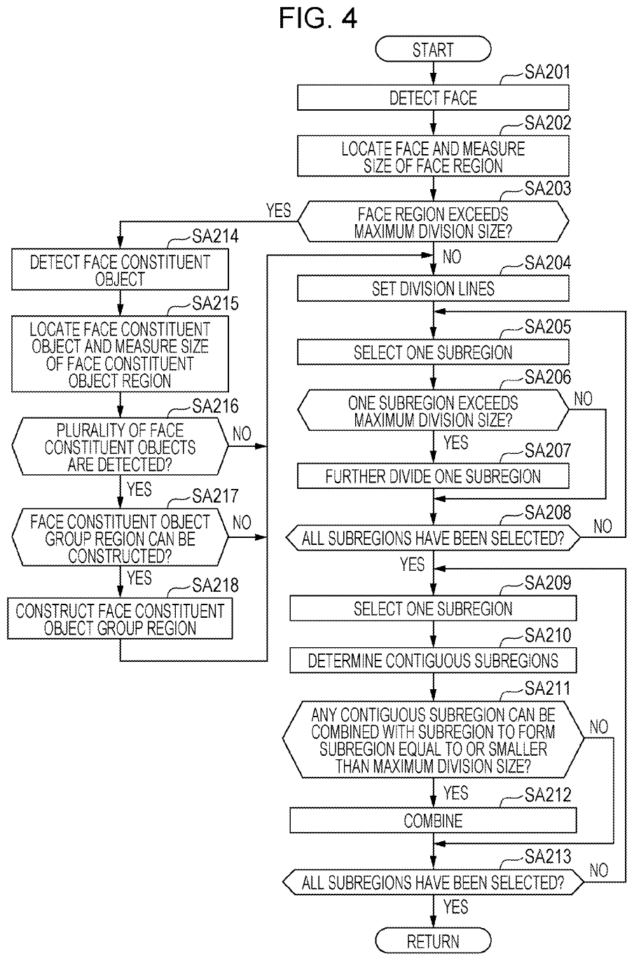

The image region division processing is a processing operation of dividing into a plurality of regions the image region GA represented by the image data GD generated by the image data generator 2110. Details of the image region division processing will be described later with reference to FIG. 4.

The image processor 2120 selects one subregion BA from the plurality of subregions BA obtained by division in the image region division processing (Step SA3).

Next, the image processor 2120 generates print data for printing a particular image section corresponding to the selected one subregion BA in the image represented by the image data GD (Step SA4).

When generating print data for printing an image section, the image processor 2120 subjects the image section to various kinds of processing such as resolution conversion, color conversion, halftone processing, rasterizing, and command assignment. The print data for printing an image section includes sectional image data that is image data of the image section.

Subsequently, the communication controller 2130 sends the print data generated by the image processor 2120 to the printer 1 by using the control apparatus communicator 21 (Step SA5). Since the print data includes sectional image data as described above, sending print data corresponds to sending sectional image data.

Next, the image processor 2120 determines whether all the subregions BA obtained by division in the image region division processing have been selected in Step SA3 (Step SA6).

In the case in which the image processor 2120 determines that not all the subregions BA have been selected in Step SA3 (NO in Step SA6), the image processor 2120 returns to Step SA3 and selects one unselected subregion BA in Step SA3, followed by Step SA4 and the subsequent processing operations performed again.

In the case in which the image processor 2120 determines that all the subregions BA obtained by division in the image region division processing have been selected in Step SA3 (YES in Step SA6), the process is ended.

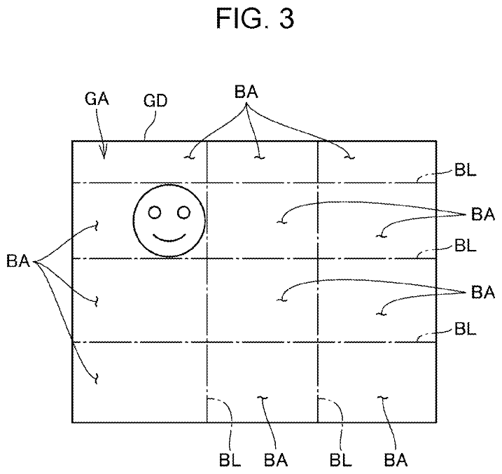

FIG. 3 illustrates an example of the image region GA divided in the image region division processing. The image region GA illustrated in FIG. 3 is divided into twelve subregions BA by five division lines BL. The division line BL is arranged in a straight line in either the vertical or horizontal direction in the image region GA.

In the case of FIG. 3, the image processor 2120 generates print data for printing an image section with respect to each subregion BA of the twelve subregions BA. Accordingly, the communication controller 2130 sends twelve pieces of print data to the printer 1.

Referring to the flowchart FB, the printer controller 10 of the printer 1 determines whether the printer communicator 11 has received print data (Step SB1).

In the case in which the printer controller 10 determines that the printer communicator 11 has received print data (YES in Step SB1), the printing unit 12 prints an image section represented by the received print data on a print medium (Step SB2).

In the case of FIG. 3, the printer 1 produces twelve prints on which different image sections are individually printed. The user can arrange and bond together the twelve prints produced by the printer 1, so that the user can obtain a single print of a desired size on which the image represented by the image data GD is printed. This printing method is called tiled printing or split printing and used for creating, for example, posters, signboards, or banners. In particular, this printing method is used to produce a single print of a size larger than the maximum width of print medium printable by the printer 1.

FIG. 4 is a flowchart illustrating an operation of the control apparatus 2 in the image region division processing. In the following description regarding the flowchart in FIG. 4, it is assumed that the image represented by the image data GD outputted by the image data generator 2110 includes a face. A face corresponds to an example of a first object.

The image processor 2120 performs the image region division processing in the state in which the image data GD outputted by the image data generator 2110 is converted into a representation based on a coordinate system in which Y and X axes are determined. Between the Y and X axes in the coordinate system, the axial direction of one axis corresponds to a transport direction of print media in the printer 1, and the axial direction of the other axis corresponds to a direction perpendicular to the transport direction. The image data GD is presented in the coordinate system such that the vertical direction of the image region GA is parallel to the Y axis and the horizontal direction of the image region GA is parallel to the X axis.

The image processor 2120 detects a face in the image represented by the image data GD outputted by the image data generator 2110 (Step SA201).

The image processor 2120 detects a face in an image in Step SA201 by employing, for example, a detection method described below. In Step SA201, the image processor 2120 moves a rectangular detection frame of a given size in the image region GA and calculates, by using a predetermined algorithm, the feature of an image division defined by the detection frame at each of the positions where the detection frame is successively moved. The image processor 2120 calculates with respect to each position a match rate between the feature calculated for the position and a predetermined feature of face and accordingly determines whether the calculated match rate is equal to or greater than a predetermined threshold. The image processor 2120 detects as a face a particular image division defined by the detection frame when the match rate of the particular image division is equal to or greater than the predetermined threshold. Changing the detection frame size enables detection of faces of different sizes in the image. The face detection method described above is a mere example and the face detection method is not limited by the above description; for example, it is possible to employ a method of detecting a face in accordance with color differences in the image.

Next, after detecting a face in the image represented by the image data GD in Step SA201, the image processor 2120 locates the detected face in the image region GA and measures the size of a face region FCA corresponding to the detected face (Step SA202). The face region FCA corresponds to an example of a first object region. The face region FCA is a rectangular region in the image region GA.

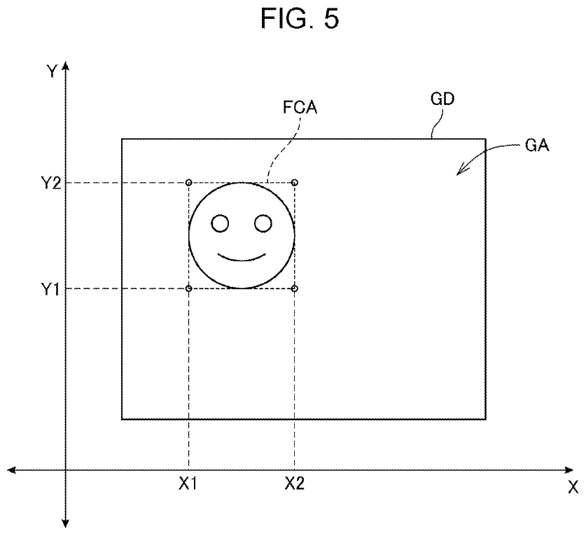

FIG. 5 is an illustration for explaining locating a face in the image region GA and measuring the size of the face region FCA. FIG. 5 indicates the case in which the image processor 2120 detects one face in the image represented by the image data GD.

Firstly, the image processor 2120 determines one particular face region FCA that includes the detected face and that is the smallest in area. The image processor 2120 may determine as the face region FCA the detection frame used when the face is detected.

The image processor 2120 calculates coordinates of the four corners of the determined face region FCA. The image processor 2120 determines the set of the calculated coordinates as the position of the face in the image region GA. In the case of FIG. 5, the image processor 2120 determines the coordinate set of (X1, Y1), (X1, Y2), (X2, Y1), and (X2, Y2) as the position of the face in the image region GA.

The image processor 2120 measures the size of the face region FCA in accordance with the coordinates of the four corners of the face region FCA. In the present embodiment, the size of the face region FCA denotes a combination of lengths of two sides perpendicular to each other, or a combination of the length of a side in the X axis and the length of a side in the Y axis. In the case of FIG. 5, the image processor 2120 determines as the size of the face region FCA the combination of the length of the side given by X2−X1 and the length of the side given by Y2−Y1.

Returning to the description of the flowchart in FIG. 4, after locating the face in the image region GA and measuring the size of the face region FCA, the image processor 2120 determines whether the measured size of the face region FCA exceeds a maximum division size (Step SA203).

The maximum division size is a maximum size of the subregion BA into which the image processor 2120 can divide the image region GA. The subregion BA is a rectangle, and thus, the maximum division size is represented by a combination of the length of a side parallel to the X axis and the length of a side parallel to the Y axis. The maximum division size is a size set by the user or a size corresponding to a maximum width of print medium that the printer 1 can print. In the case in which the maximum division size is set by the user, the combination of lengths of two sides indicated as the maximum division size is a combination of lengths set by the user. In the case in which the maximum division size corresponds to the maximum width of print medium, the lengths of two sides indicated as the maximum division size correspond to the maximum width of print medium.

In Step SA203, the image processor 2120 determines, with respect to each of the two perpendicular sides of the face region FCA, whether the length of the side exceeds the length of a corresponding side indicated by the maximum division size. Specifically, the image processor 2120 determines whether the length of a side of the face region FCA parallel to the X axis exceeds the length of one side that is indicated by the maximum division size and that is parallel to the X axis and whether the length of a side of the face region FCA parallel to the Y axis exceeds the length of the other side that is indicated by the maximum division size and that is parallel to the Y axis. In the case in which the image processor 2120 determines that neither of the two sides exceeds the maximum division size, Step SA203 is determined in the negative; in the case in which the image processor 2120 determines that either side exceeds the maximum division size, Step SA203 is determined in the affirmative. In the following description, the determination and comparison with regard to the maximum division size are performed as described above.

In the case in which the image processor 2120 determines that the size of the face region FCA is equal to or smaller than the maximum division size (NO in Step SA203), the image processor 2120 sets the division lines BL in the image region GA (Step SA204). In the processing in Step SA204 after Step SA203 is determined as NO, the image processor 2120 sets the division lines BL in the image region GA in accordance with the face region FCA.

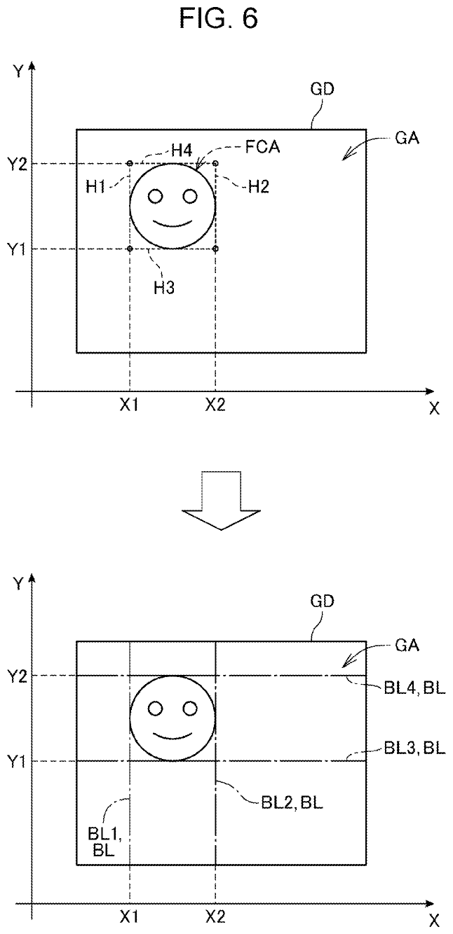

FIG. 6 is an illustration for explaining setting the division lines BL. FIG. 6 indicates the case in which the image processor 2120 detects one face in the image represented by the image data GD and the size of the face region FCA is equal to or smaller than the maximum division size.

The image processor 2120 sets the division lines BL parallel to and overlapping the sides of the face region FCA.

In the case of FIG. 6, for a side H1 indicated by a X coordinate X1 and parallel to the Y axis, the image processor 2120 sets a division line BL1 parallel to and overlapping the side H1 in the image region GA. The division line BL1 overlapping the side H1 denotes that the X coordinate of the division line BL1 is X1.

Additionally, in the case of FIG. 6, for a side H2 indicated by a X coordinate X2 and parallel to the Y axis, the image processor 2120 sets a division line BL2 parallel to and overlapping the side H2 in the image region GA. The division line BL2 overlapping the side H2 denotes that the X coordinate of the division line BL2 is X2.

Additionally, in the case of FIG. 6, for a side H3 indicated by a Y coordinate Y1 and parallel to the X axis, the image processor 2120 sets a division line BL3 parallel to and overlapping the side H3 in the image region GA. The division line BL3 overlapping the side H3 denotes that the Y coordinate of the division line BL3 is Y1.

Additionally, in the case of FIG. 6, for a side H4 indicated by a Y coordinate Y2 and parallel to the X axis, the image processor 2120 sets a division line BL4 parallel to and overlapping the side H4 in the image region GA. The division line BL4 overlapping the side H4 denotes that the Y coordinate of the division line BL4 is Y2.

Returning to the description of the flowchart in FIG. 4, after setting the division lines BL in Step SA204, the image processor 2120 selects one subregion BA from a plurality of subregions BA obtained by dividing the image region GA in accordance with the setting in Step SA204 (Step SA205).

Next, the image processor 2120 determines whether the size of the one subregion BA selected in Step SA205 exceeds the maximum division size (Step SA206).

In the case in which the size of the one subregion BA is determined not to exceed the maximum division size (NO in Step SA206), the image processor 2120 determines whether all the subregions BA obtained by dividing the image region GA in accordance with the setting in Step SA204 have been selected in Step SA205 (Step SA208).

In the case in which the image processor 2120 determines that not all the subregions BA have been selected (NO in Step SA208), the image processor 2120 returns to Step SA205 and selects one unselected subregion BA, followed by Step SA206 and the subsequent processing operations performed again.

By contrast, in the case in which all the subregions BA are determined to have been selected (YES in Step SA208), the image processor 2120 performs processing in Step SA209.

Returning to the description of Step SA206, in the case in which the size of the one subregion BA is determined to exceed the maximum division size (YES in Step SA206), the image processor 2120 sets a division line BL in the subregion BA selected in Step SA205 and further divides the subregion BA (Step SA207).

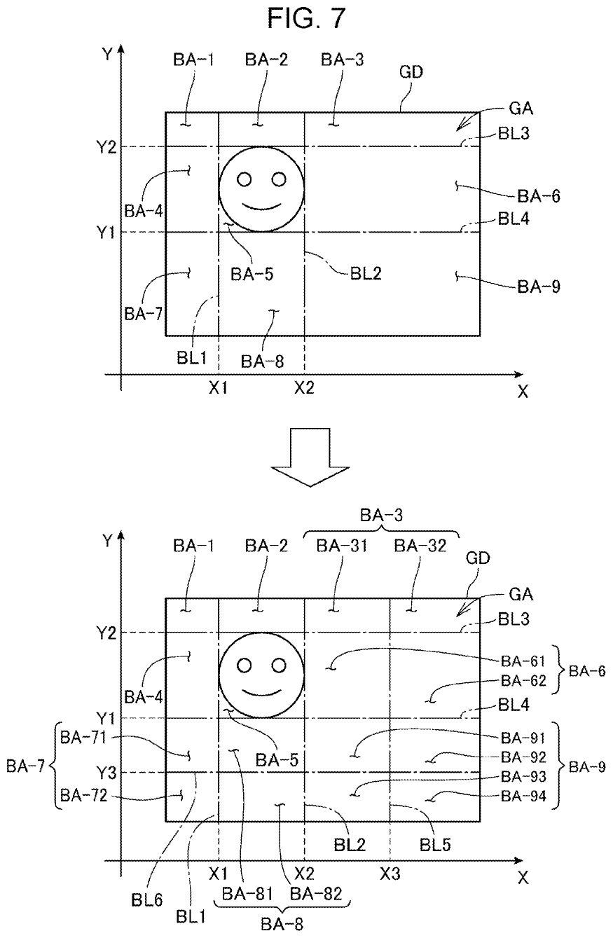

FIG. 7 is an illustration for explaining setting the division lines BL for the subregions BA.

FIG. 7 indicates the case in which the image processor 2120 detects one face in the image represented by the image data GD and the size of the face region FCA is equal to or smaller than the maximum division size. In the case indicated in FIG. 7, the image region GA is divided into nine subregions BA by setting the division lines BL1, BL2, BL3, and BL4 in Step SA204. In FIG. 7, among the nine subregions BA, subregions BA-3, BA-6, and BA-9 each have sides parallel to the X axis and exceeding the maximum division size. In FIG. 7, among the nine subregions BA, subregions BA-7, BA-8, and BA-9 each have sides parallel to the Y axis and exceeding the maximum division size.

As for subregions BA-1, BA-2, BA-4, and BA-5, the image processor 2120 determines that every side is equal to or smaller than the maximum division size and refrains from setting any division line BL.

The image processor 2120 determines that the subregions BA-3, BA-6, and BA-9 exceed the maximum division size and sets a division line BL for the subregions BA-3, BA-6, and BA-9. In FIG. 7, it is assumed that the subregions BA-3, BA-6, and BA-9 can be reduced to have sizes equal to or smaller than the maximum division size by dividing sides parallel to the X axis into two. Accordingly, in FIG. 7, the image processor 2120 sets a division line BL5 common to the subregions BA-3, BA-6, and BA-9. The X coordinate of the division line BL5 is X3 and the division line BL5 is parallel to the Y axis. The division line BL5 divides the subregion BA-3 into subregions BA-31 and BA-32 and also divides the subregion BA-6 into subregions BA-61 and BA-62. The subregion BA-9 will be described later.

The image processor 2120 determines that the subregions BA-7, BA-8, and BA-9 exceed the maximum division size and sets a division line BL for the subregions BA-7, BA-8, and BA-9. In FIG. 7, it is assumed that the subregions BA-7, BA-8, and BA-9 can be reduced to have sizes equal to or smaller than the maximum division size by dividing sides parallel to the Y axis into two. Accordingly, in FIG. 7, the image processor 2120 sets a division line BL6 common to the subregions BA-7, BA-8, and BA-9. The Y coordinate of the division line BL6 is Y3 and the division line BL6 is parallel to the X axis. The division line BL6 divides the subregion BA-7 into two subregions BA-71 and BA-72 and also divides the subregion BA-8 into two subregions BA-81 and BA-82. As for the subregion BA-9, the sides parallel to the X axis and the sides parallel to the Y axis are all divided into two, and as a result, the subregion BA-9 is sectioned into four subregions BA-91, BA-92, BA-93, and BA-94.

Returning to the description of the flowchart illustrated in FIG. 4, the image processor 2120 selects one subregion BA from a plurality of subregions BA obtained by dividing the image region GA in accordance with the setting in Steps SA204 and SA207 (Step SA209).

Next, the image processor 2120 determines particular subregions BA contiguous with any side of the subregion BA selected in Step SA209 (Step SA210). In the following description, the particular subregion BA contiguous with a side of the subregion BA selected in Step SA209 is referred to as a “contiguous subregion”.

Next, the image processor 2120 determines whether any contiguous subregion determined in Step SA210 can be combined with the subregion BA selected in Step SA209 so as to form a subregion BA equal to or smaller than the maximum division size (Step SA211).

In the case in which Step SA211 is determined in the negative, the image processor 2120 proceeds to Step SA213. By contrast, in the case in which Step SA111 is determined in the affirmative, the image processor 2120 combines a particular contiguous subregion determined to form a subregion BA equal to or smaller than the maximum division size with the subregion BA selected in Step SA209 (Step SA212).

Next, the image processor 2120 determines whether all the subregions BA obtained by dividing the image region GA in accordance with the setting in Steps SA204 and SA207 have been selected in Step SA209 (Step SA213).

In the case in which the image processor 2120 determines that not all the subregions BA have been selected (NO in Step SA213), the image processor 2120 returns to Step SA209 and selects one unselected subregion BA, followed by Step SA210 and the subsequent processing operations performed again.

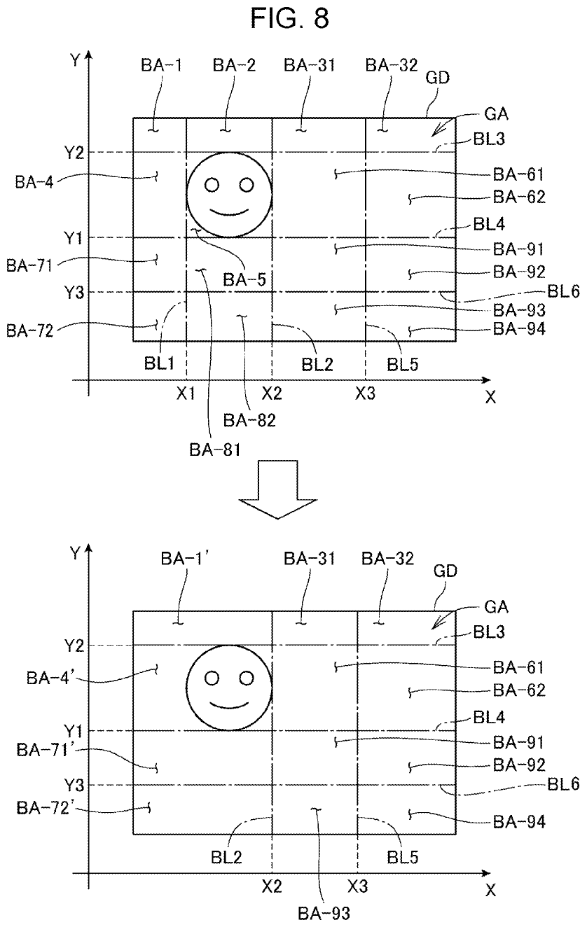

FIG. 8 is an illustration for explaining combining the subregion BA with the contiguous subregion. FIG. 8 illustrates the case in which the image processor 2120 detects one face in the image represented by the image data GD and the size of the face region FCA is equal to or smaller than the maximum division size. In the upper illustration in FIG. 8, the division lines BL1, BL2, BL3, BL4, BL5, and BL6, which are set in Steps SA204 and SA207, divide the image region GA into sixteen subregions BA.

In FIG. 8, it is assumed that a subregion formed by combining the subregions BA-1 and BA-2 is still equal to or smaller than the maximum division size. In FIG. 8, it is also assumed that a subregion formed by combining the subregions BA-4 and BA-5 is still equal to or smaller than the maximum division size. It is also assumed that a subregion formed by combining the subregions BA-71 and BA-81 is still equal to or smaller than the maximum division size. It is also assumed that a subregion formed by combining the subregions BA-72 and BA-82 is still equal to or smaller than the maximum division size.

When the subregion BA-1 is selected in Step SA209, the image processor 2120 determines the subregions BA-2 and BA-4 as contiguous subregions for the subregion BA-1 in Step SA210. Since a subregion formed by combining the subregions BA-1 and BA-2 is still equal to or smaller than the maximum division size in FIG. 8 as described above, the image processor 2120 combines the subregions BA-1 and BA-2 together to form a single subregion BA-1′.

When the subregion BA-4 is selected in Step SA209, the image processor 2120 determines the subregions BA-1, BA-5, and BA-71 as contiguous subregions for the subregion BA-4 in Step SA210. In the case in which the subregion BA-1 has been selected and combined with the subregion BA-2 before the subregion BA-4 is selected, the subregion BA-1′ instead of the subregion BA-1 is determined as a contiguous subregion for the subregion BA-4. Since a subregion formed by combining the subregions BA-4 and BA-5 is still equal to or smaller than the maximum division size in FIG. 8, the image processor 2120 combines the subregions BA-4 and BA-5 together to form a single subregion BA-4′.

When the subregion BA-71 is selected in Step SA209, the image processor 2120 determines the subregions BA-4, BA-72, and BA-81 as contiguous subregions for the subregion BA-71 in Step SA210. In the case in which the subregion BA-4 has been selected and combined with the subregion BA-5 before the subregion BA-71 is selected, the subregion BA-4′ instead of the subregion BA-4 is determined as a contiguous subregion for the subregion BA-71. Since a subregion formed by combining the subregions BA-71 and BA-81 is still equal to or smaller than the maximum division size in FIG. 8, the image processor 2120 combines the subregions BA-71 and BA-81 together to form a single subregion BA-71′.

When the subregion BA-72 is selected in Step SA209, the image processor 2120 determines the subregions BA-71 and BA-82 as contiguous subregions for the subregion BA-72 in Step SA210. In the case in which the subregion BA-71 has been selected and combined with the subregion BA-81 before the subregion BA-72 is selected, the subregion BA-71′ instead of the subregion BA-71 is determined as a contiguous subregion for the subregion BA-72. Since a subregion formed by combining the subregions BA-72 and BA-82 is still equal to or smaller than the maximum division size in FIG. 8, the image processor 2120 combines the subregions BA-72 and BA-82 together to form a single subregion BA-72′.

Returning to the description of the flowchart illustrated in FIG. 4, in the case in which all the subregions BA are determined to have been selected (YES in Step SA213), the image processor 2120 performs the processing operation in Step SA3 and the subsequent processing operations.

Specifically, when the image processor 2120 finally divides the image region GA as illustrated in FIG. 8, pieces of sectional image data of the respective subregions BA-1′, BA-31, BA-32, BA-4′, BA-61, BA-62, BA-71′, BA-91, BA-92, BA-72′, BA-93, and BA-94 are generated and sent to the printer 1.

Returning to the description of Step SA203, in the case in which the image processor 2120 determines that the size of the face region FCA exceeds the maximum division size (YES in Step SA203), the image processor 2120 detects a face constituent object that constitutes the face detected in Step SA201 (Step SA214). The face constituent object is at least any of an eye, a mouth, and a nose. The face constituent object corresponds to an example of a second object.

The image processor 2120 detects a face constituent object in the face in Step SA214 by employing, for example, a detection method described below. The image processor 2120 moves a rectangular detection frame of a given size in the face region FCA and calculates, by using a predetermined algorithm, the feature of an image division defined by the detection frame at each of the positions where the detection frame is successively moved. The image processor 2120 calculates with respect to each position a match rate between the feature calculated for the position and a predetermined feature of face constituent object and accordingly determines whether the calculated match rate is equal to or greater than a predetermined threshold. The image processor 2120 detects as a face constituent object a particular image division defined by the detection frame when the match rate of the particular image division is equal to or greater than the predetermined threshold. Changing the detection frame size enables detection of face constituent objects of different sizes in the image. The face constituent object detection method described above is a mere example and the face detection method is not limited by the above description; for example, it is possible to employ a method of detecting a face constituent object in accordance with color differences in the image.

Next, after detecting a face constituent object in Step SA214, the image processor 2120 locates the detected face constituent object in the image region GA and measures the size of a face constituent object region KOA corresponding to the face constituent object (Step SA215). The face constituent object region KOA corresponds to an example of a second object region. The face constituent object region KOA is a rectangle.

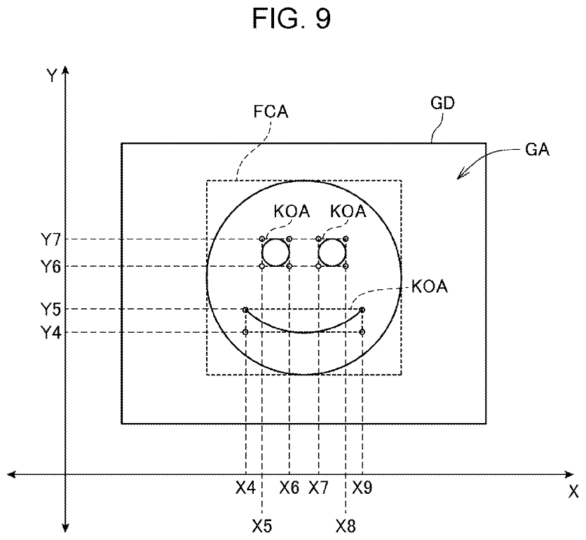

FIG. 9 is an illustration for explaining locating a face constituent object in the image region GA and measuring the size of the face constituent object region KOA.

FIG. 9 illustrates the case in which the image processor 2120 detects one face in the image represented by the image data GD.

Firstly, the image processor 2120 determines one particular face constituent object region KOA that includes a detected face constituent object and that is the smallest in area. The image processor 2120 may determine as the face constituent object region FCA the detection frame used when the face constituent object is detected.

The image processor 2120 calculates coordinates of the four corners of the determined face constituent object region KOA. The image processor 2120 determines the set of the calculated coordinates as the position of the face constituent object in the image region GA.

In the case of FIG. 9, the image processor 2120 determines the coordinate set of (X5, Y6), (X5, Y7), (X6, Y6), and (X6, Y7) as the position of a face constituent object representing a left eye in the image region GA.

In the case of FIG. 9, the image processor 2120 determines the coordinate set of (X7, Y6), (X7, Y7), (X8, Y6), and (X8, Y7) as the position of a face constituent object representing a right eye in the image region GA.

In the case of FIG. 9, the image processor 2120 determines the coordinate set of (X4, Y4), (X4, Y5), (X9, Y4), and (X9, Y5) as the position of a face constituent object representing a mouth in the image region GA.

Furthermore, the image processor 2120 measures the size of the face constituent object region KOA in accordance with the coordinates of the four corners of the face constituent object region KOA. In the present embodiment, the size of the face constituent object region KOA denotes a combination of lengths of two sides perpendicular to each other, or a combination of the length of a side parallel to the X axis and the length of a side parallel to the Y axis.

In the case of FIG. 9, the image processor 2120 determines as the size of the face constituent object region KOA of the left eye the combination of the length of the side given by X6−X5 and the length of the side given by Y7−Y6.

In the case of FIG. 9, the image processor 2120 determines as the size of the face constituent object region KOA of the right eye the combination of the length of the side given by X8−X7 and the length of the side given by Y7−Y6.

In the case of FIG. 9, the image processor 2120 determines as the size of the face constituent object region KOA of the mouth the combination of the length of the side given by X9−X4 and the length of the side given by Y5−Y4.

Returning to the description of the flowchart illustrated in FIG. 4, the image processor 2120 determines whether a plurality of face constituent objects are detected in Step SA214 (Step SA216).

In the case in which the image processor 2120 determines that a plurality of face constituent objects are not detected in Step SA214, that is, in the case in which it is determined that only one face constituent object is detected (NO in Step SA216), the image processor 2120 proceeds to Step SA204 and performs Step SA204 and the subsequent processing operations. When the image processor 2120 performs the processing in Step SA204 after performing Steps SA214 and SA215 and determining Step SA216 as NO, the image processor 2120 sets the division lines BL in accordance with the face constituent object region KOA in a manner similar to that of the face region FCA. Subsequently, the image processor 2120 performs Step SA205 and the subsequent processing operations by using the division lines BL set in accordance with the face constituent object region KOA.

By contrast, in the case in which the image processor 2120 determines that a plurality of face constituent objects are detected in Step SA214 (YES in Step SA216), the image processor 2120 determines whether it is possible to construct a rectangular region equal in size to or smaller than the maximum division size and including two or more face constituent object regions (Step SA217). In the following description, the rectangular region including two or more face constituent object regions is referred to as a “face constituent object group region” and assigned reference characters “KGA”.

In the case in which the image processor 2120 determines that it is impossible to construct any face constituent object group region KGA (NO in Step SA217), the image processor 2120 moves to Step SA204 and performs Step SA204 and the subsequent processing operations. When the image processor 2120 performs the processing in Step SA204 after performing Steps SA214 and SA215 and determining Step SA216 as YES and Step SA217 as NO, the image processor 2120 sets the division lines BL in accordance with each face constituent object region KOA in a manner similar to that of the face region FCA. Subsequently, the image processor 2120 performs Step SA205 and the subsequent processing operations by using the division lines BL set in accordance with each face constituent object region KOA.

By contrast, in the case in which the image processor 2120 determines that it is possible to construct a face constituent object group region KGA (YES in Step SA217), the image processor 2120 constructs the face constituent object group region KGA as a single face constituent object region KOA (Step SA218).

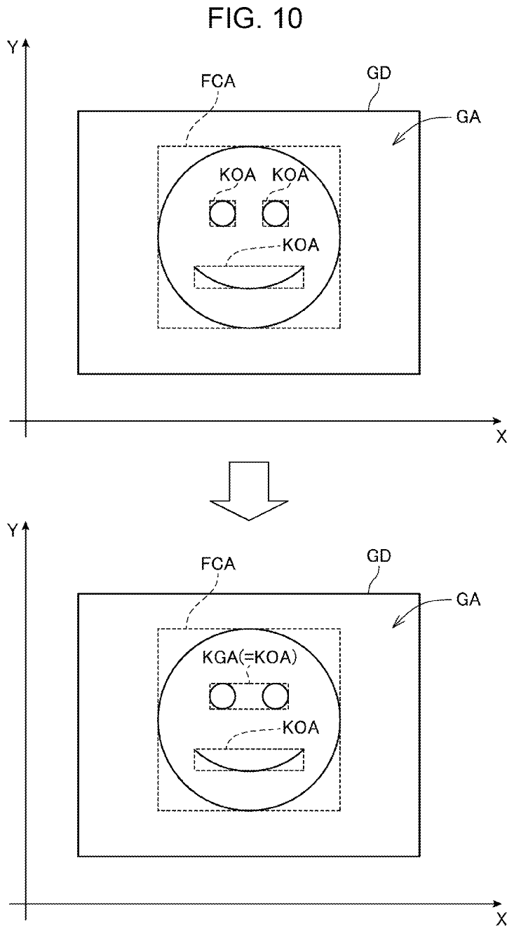

FIG. 10 is an illustration for explaining constructing the face constituent object group region KGA. FIG. 10 indicates the case in which the image processor 2120 detects one face in the image represented by the image data GD and the size of the face region FCA is larger than the maximum division size. Additionally, FIG. 10 indicates the case in which three face constituent objects of a left eye, a right eye, and a mouth are detected in the face.

Further, in FIG. 10, it is assumed that the size of a region including the face constituent object region KOA representing the left eye and the face constituent object region KOA representing the right eye is equal to or smaller than the maximum division size.

In this case, the image processor 2120 constructs, as a single face constituent object region KOA, the face constituent object group region KGA including the face constituent object region KOA corresponding to the left eye and the face constituent object region KOA corresponding to the right eye. In FIG. 10, if the size of a region including the face constituent object region KOA corresponding to the left eye, the face constituent object region KOA corresponding to the right eye, and the face constituent object region KOA corresponding to the mouth is equal to or smaller than the maximum division size, it is possible to construct the region as the face constituent object group region KGA.

Returning to the description of the flowchart in FIG. 4, after constructing the face constituent object group region KGA as a single face constituent object region KOA, the image processor 2120 proceeds to Step SA204 and performs Step SA204 and the subsequent processing operations. When the image processor 2120 performs the processing in Step SA204 after performing Steps SA214 and SA215, determining Step SA216 as YES and Step SA217 as YES, and performing Step SA218, the image processor 2120 sets the division lines BL in accordance with one or more face constituent object regions KOA in a manner similar to that of the face region FCA. Subsequently, the image processor 2120 performs Step SA205 and the subsequent processing operations by using the division lines BL set in accordance with the one or more face constituent object regions KOA.

Hereinafter, in accordance with the case in which the face constituent object group region KGA including the face constituent object region KOA representing a left eye and the face constituent object region KOA representing a right eye is constructed as a single face constituent object region KOA as in FIG. 10, the processing operation in Step SA204 and the subsequent processing operations will be specifically discussed.

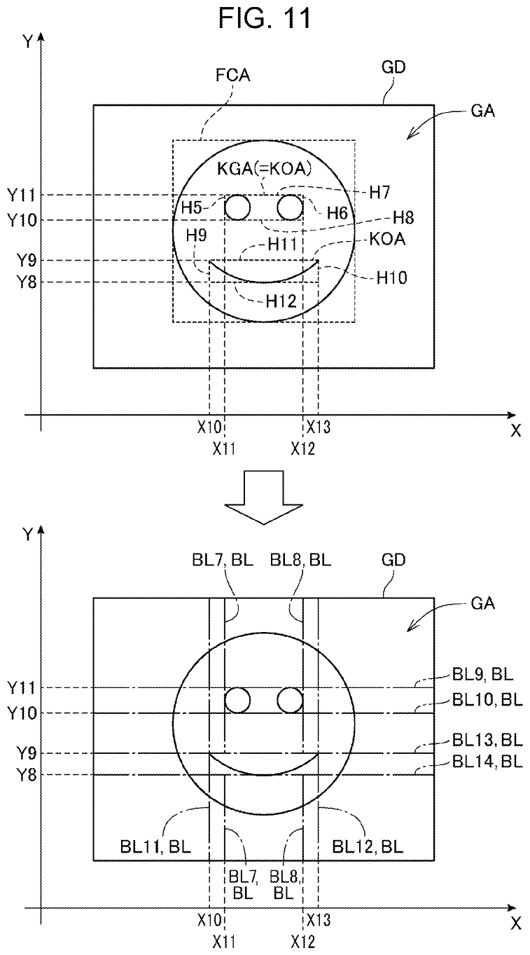

FIG. 11 is an illustration for explaining setting the division lines BL. FIG. 11 indicates the case in which the image processor 2120 detects one face in the image represented by the image data GD and the size of the face region FCA is larger than the maximum division size. Additionally, FIG. 11 illustrates the case in which three face constituent objects of a left eye, a right eye, and a mouth are detected in the face. Furthermore, FIG. 11 indicates the face constituent object region KOA including the left and right eyes, which is constructed as the face constituent object group region KGA, and the face constituent object region KOA including the mouth.

The image processor 2120 sets the division lines BL parallel to and overlapping the sides of the face constituent object region KOA.

With respect to the face constituent object region KOA including the left and right eyes, the image processor 2120 sets the division lines BL as described below.

In the case of FIG. 11, for a side H5 indicated by a X coordinate X11 and parallel to the Y axis, the image processor 2120 sets a division line BL7 parallel to and overlapping the side H5 in the image region GA. The division line BL7 overlapping the side H5 denotes that the X coordinate of the division line BL7 is X11. It should be noted that the image processor 2120 refrains from setting the division line BL7 within the face constituent object region KOA including the mouth. This is because the mouth may otherwise be divided into a plurality of discrete subregions BA in Step SA210 and the subsequent processing operations.

In the case of FIG. 11, for a side H6 indicated by a X coordinate X12 and parallel to the Y axis, the image processor 2120 sets a division line BL8 parallel to and overlapping the side H6 in the image region GA. The division line BL8 overlapping the side H6 denotes that the X coordinate of the division line BL8 is X12. It should be noted that the image processor 2120 refrains from setting the division line BL8 within the face constituent object region KOA including the mouth. This is because, the mouth may otherwise be divided into a plurality of discrete subregions BA in Step SA210 and the subsequent processing operations.

In the case of FIG. 11, for a side H7 indicated by a Y coordinate Y11 and parallel to the X axis, the image processor 2120 sets a division line BL9 parallel to and overlapping the side H7 in the image region GA. The division line BL9 overlapping the side H7 denotes that the Y coordinate of the division line BL9 is Y11.

In the case of FIG. 11, for a side H8 indicated by a Y coordinate Y10 and parallel to the X axis, the image processor 2120 sets a division line BL10 parallel to and overlapping the side H8 in the image region GA. The division line BL10 overlapping the side H8 denotes that the Y coordinate of the division line BL10 is Y10.

With respect to the face constituent object region KOA including the mouth, the image processor 2120 sets the division lines BL as described below.

In the case of FIG. 11, for a side H9 indicated by a X coordinate X10 and parallel to the Y axis, the image processor 2120 sets a division line BL11 parallel to and overlapping the side H9 in the image region GA. The division line BL11 overlapping the side H9 denotes that the X coordinate of the division line BL11 is X10.

In the case of FIG. 11, for a side H10 indicated by a X coordinate X13 and parallel to the Y axis, the image processor 2120 sets a division line BL12 parallel to and overlapping the side H10 in the image region GA. The division line BL12 overlapping the side H10 denotes that the X coordinate of the division line BL12 is X13.

In the case of FIG. 11, for a side H11 indicated by a Y coordinate Y9 and parallel to the X axis, the image processor 2120 sets a division line BL13 parallel to and overlapping the side H11 in the image region GA. The division line BL13 overlapping the side H11 denotes that the Y coordinate of the division line BL13 is Y9.

In the case of FIG. 11, for a side H12 indicated by a Y coordinate Y8 and parallel to the X axis, the image processor 2120 sets a division line BL14 parallel to and overlapping the side H12 in the image region GA. The division line BL14 overlapping the side H12 denotes that the Y coordinate of the division line BL14 is Y8.

After setting the division lines BL in FIG. 11, the image processor 2120 performs Steps SA205 to SA208, and afterward, Steps SA209 to SA213.

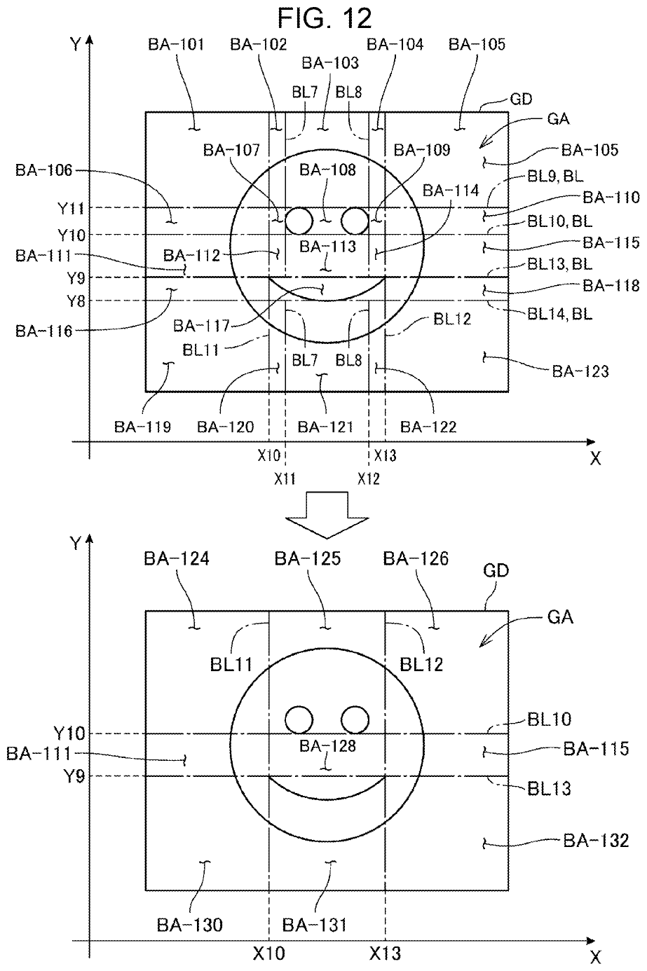

FIG. 12 is an illustration for explaining combining the subregion BA with the contiguous subregion.

FIG. 12 firstly illustrates the division lines BL after Steps SA205 to SA208 are performed in accordance with the division lines BL illustrated in FIG. 11. More specifically, FIG. 12 illustrates the image region GA without any additional division line BL after Steps SA205 to SA208 are performed in accordance with the division lines BL illustrated in FIG. 11.

In the case indicated in FIG. 12, the image region GA is divided into twenty-three subregions BA by setting the division lines BL7, BL8, BL9, BL10, BL11, BL12, BL13, and BL14.

In FIG. 12, it is assumed that a subregion formed by combining the subregions BA-101 and BA-106 is still equal to or smaller than the maximum division size. In FIG. 12, it is also assumed that a subregion formed by combining the subregions BA-102, BA-103, BA-104, BA-107, BA-108, and BA-109 is still equal to or smaller than the maximum division size. In FIG. 12, it is also assumed that a subregion formed by combining the subregions BA-105 and BA-110 is still equal to or smaller than the maximum division size. In FIG. 12, it is also assumed that a subregion formed by combining the subregions BA-112, BA-113, and BA-114 is still equal to or smaller than the maximum division size. In FIG. 12, it is also assumed that a subregion formed by combining the subregions BA-116 and BA-119 is still equal to or smaller than the maximum division size. In FIG. 12, it is also assumed that a subregion formed by combining the subregions BA-117, BA-120, BA-121, and BA-122 is still equal to or smaller than the maximum division size. In FIG. 12, it is also assumed that a subregion formed by combining the subregions BA-118 and BA-123 is still equal to or smaller than the maximum division size.

In the case of FIG. 12, the image processor 2120 performs Steps SA209 to SA213 and constructs a single subregion BA-124 by combining the subregions BA-101 and BA-106. In the case of FIG. 12, the image processor 2120 performs Steps SA209 to SA213 and constructs a single subregion BA-125 by combining the subregions BA-102, BA-103, BA-104, BA-107, BA-108, and BA-109. In the case of FIG. 12, the image processor 2120 performs Steps SA209 to SA213 and constructs a single subregion BA-128 by combining the subregions BA-112, BA-113, and BA-114. In the case of FIG. 12, the image processor 2120 performs Steps SA209 to SA213 and constructs a single subregion BA-130 by combining the subregions BA-116 and BA-119. In the case of FIG. 12, the image processor 2120 performs Steps SA209 to SA213 and constructs a single subregion BA-131 by combining the subregions BA-117, BA-120, BA-121, and BA-122. In the case of FIG. 12, the image processor 2120 performs Steps SA209 to SA213 and constructs a single subregion BA-132 by combining the subregions BA-118 and BA-123.

Consequently, when the image processor 2120 finally divides the image region GA as illustrated in FIG. 12, the image processor 2120 generates pieces of print data of the respective nine subregions BA-124, BA-125, BA-126, BA-111, BA-128, BA-115, BA-130, BA-131, and BA-132.

In the above description, it is assumed that the face constituent object region KOA is equal to or smaller than the maximum division size. When the face constituent object region KOA exceeds the maximum division size, the image processor 2120 may divide the face constituent object region KOA into a plurality of subregions BA. In this case, the image processor 2120 may provide, by using the control apparatus display 23, notification that the printer 1 prints a face constituent object in a divided manner.

Furthermore, in the above description it is assumed that one face is detected in the image represented by the image data GD; but when a plurality of faces are detected, the image processor 2120 performs the operation described below.

In the case in which all face regions FCA are equal to or smaller than the maximum division size, the image processor 2120 performs Step SA215 and the subsequent processing operations with respect to the faces and the face regions FCA instead of the face constituent objects and the face constituent object regions KOA.

In the case in which all the face regions FCA exceed the maximum division size, the image processor 2120 performs Steps SA214 and SA215 with respect to all the faces and subsequently performs Step SA216 and the subsequent processing operations.

In the case in which, for example, one face region FCA is equal to or smaller than the maximum division size and the other face region FCA exceeds the maximum division size, the image processor 2120 firstly detects a face constituent object in the latter face region FCA, locates the face constituent object, and measures the size of the face constituent object region KOA of the face constituent object; the image processor 2120 secondly performs Step SA217 and the subsequent processing operations in accordance with the former face region FCA and the face constituent object region KOA detected in the latter face region FCA.

As described above, the control apparatus 2 divides the image region GA represented by the image data GD into a plurality of regions and sends pieces of sectional image data corresponding to the subregions BA to the printer 1. The control apparatus 2 includes the image processor 2120 configured to detect a face in the image represented by the image data GD, locate the detected face in the image region GA, and divide the image region GA in accordance with the position of the face in the image region GA such that the subregion BA includes the face constituent object region KOA corresponding to the face constituent object.

The method of controlling the control apparatus 2 includes detecting a face in the image represented by the image data GD, locating the detected face in the image region GA, and dividing the image region GA in accordance with the position of the face in the image region GA such that the subregion BA includes the face constituent object region KOA corresponding to the face constituent object.

The second program 220D executed by the control apparatus controller 20 of the control apparatus 2 causes the control apparatus controller 20 to perform control to detect a face in the image represented by the image data GD, locate the detected face in the image region GA, and divide the image region GA in accordance with the position of the face in the image region GA such that the subregion BA includes the face constituent object region KOA corresponding to the face constituent object.

By employing the control apparatus 2, the method of controlling the control apparatus 2, and the second program 220D, the image region GA is divided such that the subregion BA includes the face constituent object region KOA, and thus, the image represented by the image data GD can be automatically divided such that no face constituent object is divided into a plurality of image sections. Furthermore, since the image represented by the image data can be automatically divided such that no face constituent object is divided into a plurality of image sections, the user does not need to do laborious work for preventing any face constituent object from being divided into a plurality of image sections, and thus, printing can be promptly started. Moreover, this can avoid a low quality print problem in which a face constituent object is misshaped due to misalignment or the like when a plurality of prints are arranged and bonded together to obtain a single print.

The image processor 2120 divides the image region GA in accordance with the maximum division size that is a size set by the user or a size corresponding to a maximum print medium width printable by the printer 1.

With this configuration, the size of the subregion BA does not exceed the size set by the user or the size corresponding to the maximum print medium width printable by the printer 1, and as a result, the printer 1 can produce a print in which an image section corresponding to the subregion BA is completely printed. Accordingly, when a plurality of prints are arranged and bonded together to obtain a single print, it is possible to avoid the occurrence of a missing portion in the image represented by the image data GD.

When the size of a particular subregion BA not including the face constituent object region KOA exceeds the maximum division size, the image processor 2120 further divides the particular subregion BA not including the face constituent object region KOA so as not to exceed the maximum division size.

With this configuration, the size of the subregion BA not including any face constituent object falls below the maximum division size, and as a result, the printer 1 can produce a print in which an image section corresponding to the subregion BA not including any face constituent object is completely printed. Accordingly, when a plurality of prints are arranged and bonded together to obtain a single print, it is possible to avoid the occurrence of a missing portion in the image represented by the image data GD.

In the case in which the size of the face region FCA corresponding to the detected face is equal to or smaller than the maximum division size, the image processor 2120 divides the image region GA such that the subregion BA includes the face region FCA and the face constituent object region KOA.

With this configuration, it is possible to automatically divide the image represented by the image data GD so as to avoid unnecessary division of the face into a plurality of image sections. As a result, this can avoid a low quality print problem in which a face is misshaped due to misalignment or the like when a plurality of prints are arranged and bonded together to obtain a single print.

When the size of the face region FCA corresponding to the detected face exceeds the maximum division size, the image processor 2120 detects a face constituent object in the face, locates the detected face constituent object in the image region GA, and divides the image region GA in accordance with the position of the face in the image region GA such that the subregion BA includes the face constituent object region KOA.

With this configuration, the processing regarding face constituent objects is performed only when the size of the face region FCA exceeds the maximum division size, and thus, it is possible to prevent the processing regarding face constituent objects from being unnecessarily performed, resulting in prompt and efficient division of the image region GA.

When two or more face constituent objects are detected in the face and it is possible to construct in the image region GA the face constituent object group region KGA not exceeding the maximum division size and including the two or more face constituent object regions, the image processor 2120 divides the image region GA to determine the face constituent object group region KGA as a single face constituent object region KOA.

With this configuration, the image region GA can be divided such that a single subregion BA includes as many face constituent objects as possible, and as a result, it is possible to reduce the number of prints produced by the printer 1 and the printer 1 can print in a manner in which a single print includes as many face constituent objects as possible. Accordingly, it is possible to properly avoid misalignment caused when a single print is composed of a plurality of prints and also reliably hinder deterioration of print quality with respect to the single print.

The face constituent object is at least any of an eye, a nose, and a mouth.

With this configuration, it is possible to automatically divide the image represented by the image data GD so as to avoid division of at least any of an eye, a nose, and a mouth into a plurality of image sections.

The embodiment described above illustrates merely one aspect of the present disclosure and can be changed or applied in any manner within the scope of the present disclosure.

For example, while the embodiment described above uses as an example the case in which the face constituent object is at least any of an eye, a mouth, and a nose, the face constituent object is not limited to these instances and instances of the face constituent object may include, for example, an eyebrow and an ear. Furthermore, while in the embodiment a face exemplifies the first object detected in an image, the first object is not limited to a face and may be an object such as a building or a plant. When the first object is a building, a window and a roof exemplify the second object. When the first object is a plant, a leaf and a flower exemplify the second object.

Moreover, for example, while the embodiment uses as an example of the image processing apparatus the control apparatus 2 configured to communicate with the printer 1, the image processing apparatus may be a server apparatus capable of establishing connection with a global network. In the case of this configuration, the printer 1 establishes connection with the global network and receives print data from the image processing apparatus serving as a cloud server. In the case of this configuration, the control apparatus 2 establishes connection with the global network and receives sectional image data from the image processing apparatus serving as a cloud server. In accordance with the received sectional image data, the control apparatus 2 generates print data and sends the generated print data to the printer 1.

Further, for example, while in the embodiment the control apparatus 2 generates print data, the printer 1 may generate print data. In the case of this configuration, the control apparatus 2 sends sectional image data to the printer 1 and the printer 1 generates print data in accordance with the received sectional image data.

For example, while the embodiment uses as an example the case of the printer 1 with a serial ink jet head, the printer 1 may include a line ink jet head. Furthermore, while the printer 1 exemplifies the printing apparatus of the present disclosure, the printing apparatus of the present disclosure is not limited to the printer 1 and may be a multifunction device having a scanning function, a facsimile function, and the like.

For example, the function of the printer controller 10 and the function of the control apparatus controller 20 may be implemented by using a plurality of processors or a semiconductor chip.

For example, the units illustrated in FIG. 1 are mere an example and the specific application form is not limited to the example. This means that hardware devices are not necessarily provided to correspond to the respective units and a single processor can implement the functions of the units by running a program. In addition, one or more functions implemented by using software in the embodiment described above may be implemented by using hardware; or one or more functions implemented by using hardware may be implemented by using software. Specific configurations of the units of the printer 1 and the control apparatus 2 can be changed without departing from the scope of the present disclosure.

For example, the step units of operations illustrated in FIGS. 2 and 4 are determined by division based on the main processing contents for ease of understanding of operations of the units of the printing system 1000 and the present disclosure is not limited by the method of division of processing units or the names of the processing units. Depending on the processing contents, the operations may be divided into step units more than the step units in the embodiment. In addition, the division may be performed in a manner in which one step unit includes more processing operations. The order of the steps may be changed as appropriate without obstructing the scope of the present disclosure.

What is claimed is:

1. An image processing apparatus for dividing an image region represented by image data into a plurality of subregions and sending sectional image data corresponding to the subregions to a printing apparatus, comprising:
an image processor configured to
detect a first object in an image represented by the image data,
determine a position of the detected first object in the image region, and
in accordance with the determined position of the first object in the image region, divide the image region such that any of the subregions contains at least one second object region corresponding to at least one second object constituting the first object.

2. The image processing apparatus according to claim 1, wherein
the image processor is configured to divide the image region in accordance with a maximum size for determining each subregion of the subregions, the maximum size being a size set by a user or a size corresponding to a maximum print medium width printable by the printing apparatus.

3. The image processing apparatus according to claim 2, wherein
the image processor is configured to, when a particular subregion included among the subregions and not containing the at least one second object region exceeds the maximum size, further divide the particular subregion not containing the at least one second object region so as not to exceed the maximum size.

4. The image processing apparatus according to claim 2, wherein
the image processor is configured to, when a first object region corresponding to the detected first object is equal to or smaller than the maximum size, divide the image region such that any of the subregions contains the first object region and the at least one second object region.

5. The image processing apparatus according to claim 2, wherein
the image processor is configured to, when a first object region corresponding to the detected first object exceeds the maximum size,
detect the at least one second object in the first object,
determine a position of the detected at least one second object in the image region, and
in accordance with the determined position of the at least one second object in the image region, divide the image region such that any of the subregions includes the at least one second object region.

6. The image processing apparatus according to claim 5, wherein
the image processor is configured to, when the at least one second object includes two or more second objects, the at least one second object region includes two or more second object regions, the image processor detects the two or more second objects in the first object, and it is possible to construct in the image region a particular region containing the two or more second object regions and not exceeding the maximum size, divide the image region to determine the particular region as one second object region of the at least one second object region.

7. The image processing apparatus according to claim 1, wherein
the first object is a face, and
the second object is at least any of an eye, a nose, and a mouth.

8. A method of controlling an image processing apparatus for dividing an image region represented by image data into a plurality of subregions and sending sectional image data corresponding to the subregions to a printing apparatus, comprising:
detecting a first object in an image represented by the image data;
determining a position of the detected first object in the image region; and
in accordance with the determined position of the first object in the image region, dividing the image region such that any of the subregions contains at least one second object region corresponding to at least one second object constituting the first object.

9. A non-transitory computer-readable storage medium storing a program that causes a controller of an image processing apparatus to execute a process, the image processing apparatus being configured to divide an image region represented by image data into a plurality of subregions and send sectional image data corresponding to the subregions to a printing apparatus, the process comprising:
detecting a first object in an image represented by the image data;
determining a position of the detected first object in the image region; and
in accordance with the determined position of the first object in the image region, dividing the image region such that any of the subregions contains at least one second object region corresponding to at least one second object constituting the first object.
